(19) United States
(12) Patent Application Publication
(10) Pub. No.: US 2010/0167249 A1
(43) Pub. Date: Jul. 1, 2010

(54) Surgical training simulator having augmented reality

(75) Inventor: Donncha Ryan, Dublin (IE)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Haptica Ltd.

(21) Appl. No.: 12/318,599

(22) Filed: Dec. 31, 2008

(51) Int. Cl. G09B 23/30

(52) U.S. Cl. 434/267

(57) ABSTRACT

A surgical training device includes a body form, an optical tracking system within the body form, and a camera configured to be optically tracked and to obtain images of at least one surgical instrument located within the body form. The surgical training device further includes a computer configured to receive signals from the optical tracking system, and a display operatively coupled to the computer and operative to display the images of at least one surgical instrument and a virtual background, the virtual background depicting a portion of a body cavity, the virtual background displayed from a perspective of the camera configured to be optically tracked.

### TECHNICAL FIELD

The present disclosure relates to a surgical training simulator and, more particularly, to a method and apparatus for the training of surgical procedures.

### BACKGROUND

The rapid pace of recent health care advancements offers tremendous promise for those with medical conditions previously requiring traditional surgical procedures. Specifically, many procedures routinely done in the past as “open” surgeries can now be carried out far less invasively, often on an outpatient basis. In many cases, exploratory surgeries have been completely replaced by these less invasive surgical techniques. However, the very reduction to the patient in bodily trauma, time spent in the hospital, and post-operative recovery using a less invasive technique may be matched or exceeded by the technique's increased complexity for the surgeon. Consequently, enhanced surgical training for these techniques is of paramount importance to meet the demands for what have readily become the procedures of choice for the medical profession.

In traditional open surgeries, the operator has a substantially full view of the surgical site. This is rarely so with less invasive techniques, in which the surgeon is working in a much more confined space through a smaller incision and cannot directly see the area of operation. To successfully perform a less invasive surgery involves not only increased skill but unique surgical equipment. In addition to specially tailored instruments, such a procedure typically requires an endoscope, a device that can be inserted in either a natural opening or a small incision in the body. Endoscopes are typically tubular in structure and provide light to and visualization of an interior body area through use of a camera system. In use, the surgeon or an endoscope operator positions the endoscope according to the visualization needs of the operating surgeon. Often, this is done in the context of abdominal surgery. In such an abdominal procedure, a specific type of endoscope, called a laparoscope, is used to visualize the stomach, liver, intestines, and other abdominal organs.

While traditional surgical training relied heavily on the use of cadavers, surgical training simulators have gained widespread use as a viable alternative. Due to the availability of increasingly sophisticated computer technology, these simulators more effectively assess training progress and significantly increase the amount of repetitive training possible. Such simulators may be used for a variety of surgical training situations depending on the type of training desired.

To provide the most realistic training possible, a surgical training simulator for such an abdominal procedure includes a replication of a body torso, an area on the replication specifically constructed for instrument insertion, and proper display and tracking of the instruments for training purposes. Because these simulators do not contain actual abdominal organs, the most advanced among them track the movement of the instruments and combine that with a virtual reality environment, providing a more realistic surgical setting to enhance the training experience. Virtual reality systems provide the trainee with a graphical representation of an abdominal cavity on the display, giving the illusion that the trainee is actually working within an abdominal cavity. For example, U.S. Patent Application Publication 2005/0084833 (the '833 publication), to Lacey et al., discloses a surgical training simulator used for laparoscopic surgery. The simulator has a body form including a skin-like panel for insertion of the instruments, and cameras within to capture video images of the instruments as they move. The cameras are connected to a computer that includes a motion analysis engine for processing these camera images using stereo triangulation techniques with calibration of the space within the body form to provide 3D location data of the instruments. This optical tracking method allows the trainee to practice with actual and unconstrained surgical instruments during a training exercise. A graphics engine is capable of rendering a virtual abdominal environment as well as a virtual model of the instrument using the 3D location data generated. A view manager of the graphics engine also accepts inputs indicating the desired camera angle such that the view of the virtual environment may be displayed from that selected camera angle. When the rendered instrument is moved within the virtual environment, the graphics engine distorts the surface area of the rendered abdominal organs affected, displaying this motion on the computer display screen. The instrument movements may correspond to incising, cauterizing, suturing, or other surgical techniques, therefore presenting a realistic surgical environment not otherwise obtainable without the use of an actual body. The cameras of the '833 publication may also provide direct images of the moving instrument through the computer and combine those images of the live instrument with the rendered abdominal environment, producing an “augmented” reality. This augmented reality further improves the training effect.

While the cameras of the '833 publication are mobile, each time a camera is moved within the body form, its position must be separately input into the computer. Therefore, it may be desired to continuously track, with six degrees of freedom, the movement of a mobile camera during a training procedure as it provides video images of the instruments within the body form. By continuously tracking the position and alignment, and therefore the vantage point, of the mobile camera, the surgical training simulator may render a continual virtual reality simulation from that moving vantage point. This continual virtual reality simulation will more accurately match the actual video image of the instruments taken by the same mobile camera. A virtual reality simulation generated from this vantage point may be desired to improve the level of augmented reality achievable, for example, through improved simulations of object displacement in response to instrument movement, and to also provide more flexibility throughout the training procedure. All of this offers a more sophisticated augmented reality experience, enhancing the value of the training received.

The present disclosure is directed to overcoming one or more of the shortcomings set forth above and/or other shortcomings in existing technology.

### SUMMARY

A surgical training device includes a body form, an optical tracking system within the body form, and a camera configured to be optically tracked and to obtain images of at least one surgical instrument located within the body form. The surgical training device further includes a computer configured to receive signals from the optical tracking system, and a display operatively coupled to the computer and operative to display the images of at least one surgical instrument and a virtual background, the virtual background depicting a portion of a body cavity, the virtual background displayed from a perspective of the camera configured to be optically tracked.

A method of surgical training includes obtaining image data of at least one surgical instrument from a camera located within a body form, optically tracking the camera, transmitting signals corresponding to position and alignment information of the camera, and receiving the signals in a computer. The method further includes displaying the image data of the least one surgical instrument, and displaying from a perspective of the camera a virtual background, the virtual background depicting a portion of a body cavity.

A method of surgical training includes obtaining image data of at least one surgical instrument from a camera located within a body form, optically tracking the camera, transmitting signals corresponding to position and alignment information of the camera, receiving the signals in a computer, and generating three dimensional position and alignment data for the camera. The method further includes comparing the position and alignment data with at least one digitally stored model of the at least one camera, and displaying the image data of the least one surgical instrument, and displaying from a perspective of the camera a virtual background, the virtual background depicting a portion of a body cavity.

### BRIEF DESCRIPTION OF THE DRAWINGS

FIG. 1 is a perspective view of a surgical training simulator in accordance with the present disclosure;

FIG. 2 is a lengthwise cross sectional view of a body form of the surgical training simulator;

FIG. 3 is a plan view of a body form of the surgical training simulator;

FIG. 4 is a block diagram showing selected inputs and outputs of a computer of the surgical training simulator;

FIG. 4a is a flow diagram showing selected steps performed within a motion analysis engine of the surgical training simulator; and

FIGS. 5 to 9 are flow diagrams illustrating processing operations of the surgical training simulator.

### DETAILED DESCRIPTION

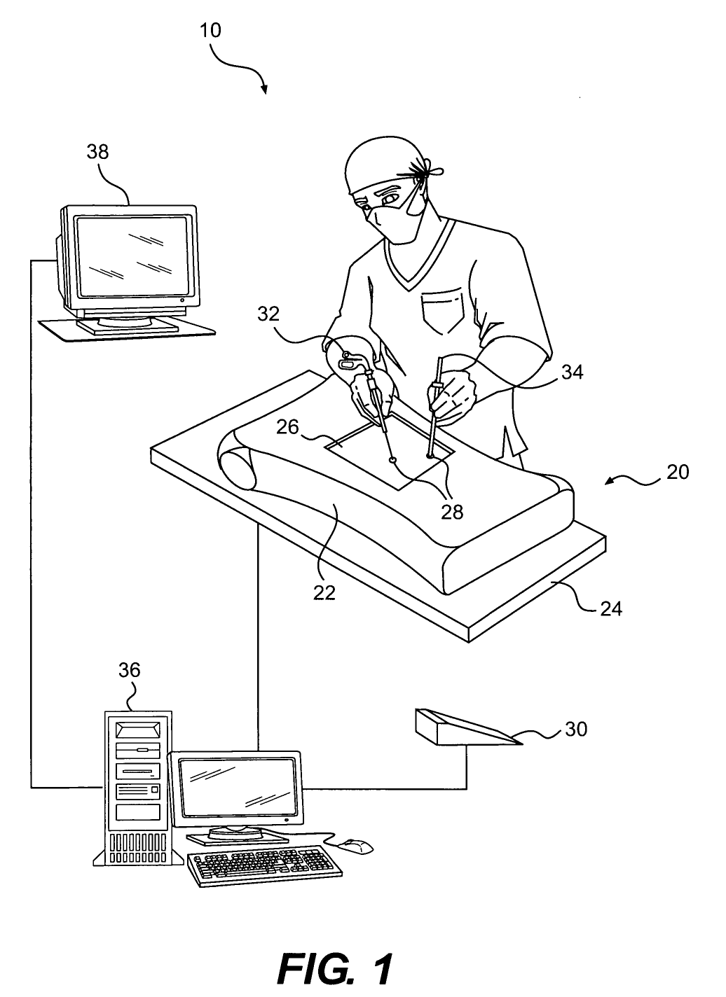

FIG. 1 illustrates an exemplary surgical training simulator 10. Surgical training simulator 10 may include a body form apparatus 20 which may comprise a body form 22. Body form 22 may be substantially hollow and may be constructed of plastic, rubber, or other suitable material. For support and to further replicate surgical conditions, body form 22 may rest upon a table 24. Body panel 26 overlays a section of body form 22 and may be made of a flexible material that simulates skin. Body panel 26 may include one or more apertures 28 for reception of one or more surgical implements during a training procedure, such as instruments 32 and/or scope camera 34. In particular, instruments 32 may, for example, be laparoscopic scissors, dissectors, graspers, probes, or other instruments for which training is desired, and one or more instruments 32 may be the same instrument used in an actual surgical procedure. Scope camera 34 may be a web or similar camera and may be manipulated externally from body form 22, preferably by use of a handle or other suitable structure, to provide a proximate view of instruments 32 within body form 22, as will be further described below. Various components of surgical training simulator 10 may be connected, directly or indirectly, to a computer 36 that receives data produced during training and processes that data. Specifically, computer 36 may include software programs with algorithms for calculating the location of surgical implements within body form 22 to assess the skill of the surgical trainee. Surgical training simulator 10 may include a monitor 38 operatively coupled to computer 36 for displaying training results, real images, graphics, training parameters, or a combination thereof, in a manner that a trainee can view both to perform the training and assess proficiency. The trainee may directly control computer 36, and thus, the display of monitor 38. Optionally, a foot pedal 30 may permit control of computer 36 in a manner similar to that of a computer mouse, thus freeing up the trainee's hands for the surgical simulation.

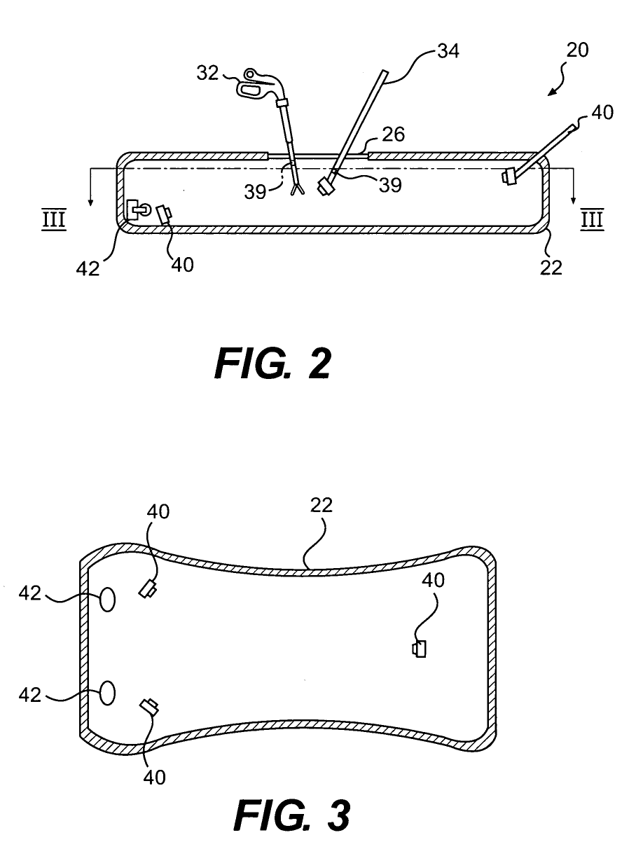

As shown in FIGS. 2 and 3, body form 22 includes a plurality of cameras 40. Cameras 40 may be fixed, although one or more may, with the aid of a handle or similar structure, be translationally and/or rotationally movable within body form 22. Both the position and number of cameras 40 within body form 22 may differ from the arrangement shown in FIGS. 2 and 3. Also located within body form 22 may be one or more light sources 42. Light sources 42 are preferably fluorescent and operate at a significantly higher frequency than the image acquisition frequency of cameras 40 or scope camera 34, thereby preventing strobing or other effects that may degrade the quality and consistency of those images obtained. As shown in the embodiment of FIG. 3, three cameras 40 may be situated within body form 22 to capture visual images of one or more instrument 32 and/or scope camera 34 when the instruments are inserted through body panel 26. Cameras 40 are in communication with computer 36 and provide visual images for a calculation in computer 36, e.g., using stereo triangulation techniques, of the six degrees of freedom (position (x,y,z) and alignment (pitch, roll, yaw)) of instruments 32 and scope camera 34 in a Cartesian coordinate system. Instruments 32 and scope camera 34 may be marked with one or more rings or other markings 39 at known positions to facilitate this optical tracking calculation. In additional embodiments, instruments 32 and/or scope camera 34 may alternatively or additionally be magnetically tracked using a commercially available magnetic tracking system. Position and alignment data of scope camera 34 may also be obtained using other vision and image processing techniques commonly known in the art.

As noted, the trainee may selectively manipulate scope camera 34 to provide proximate images within body form 22, to computer 36, for example, images of instruments 32. Scope camera 34 may be manipulated through a full six degrees of freedom. In one embodiment, cameras 40 may solely be used for optically tracking one or more instruments 32 and/or scope camera 34, while scope camera 34 may be used to provide the images of instruments 32 for viewing and/or further processing, as will be further described.

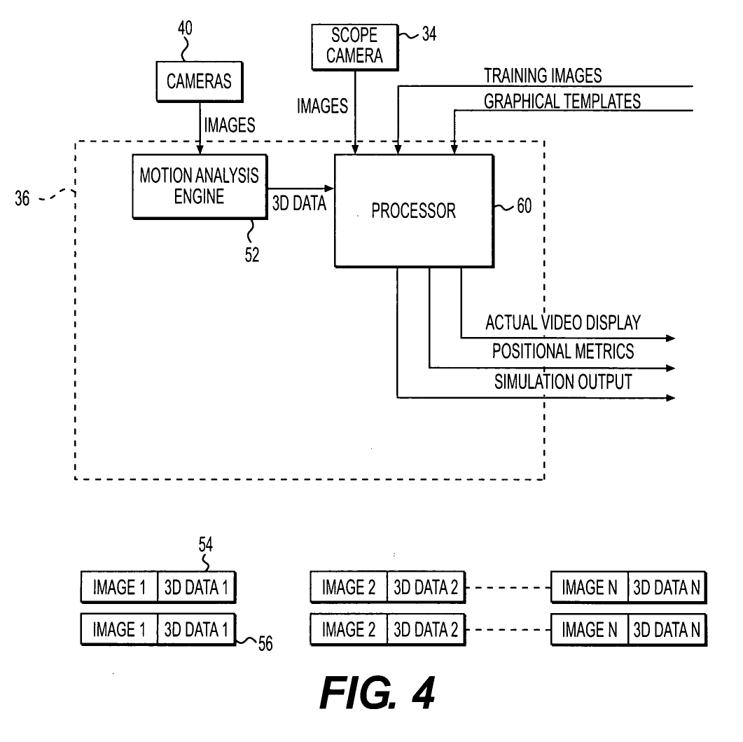

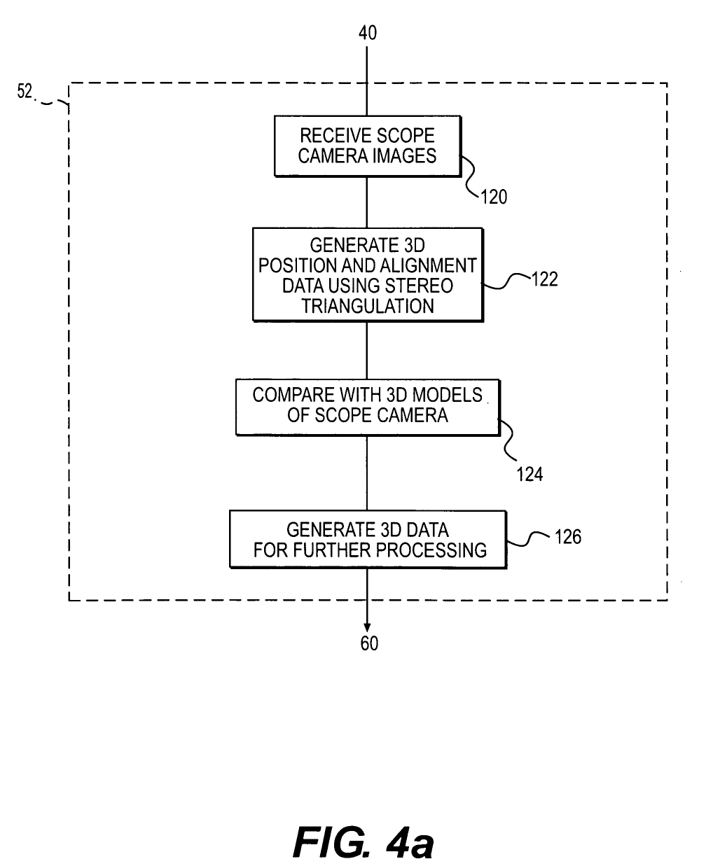

Referring to FIG. 4, in the embodiment shown, a motion analysis engine 52 receives images of instruments 32 and scope camera 34 from cameras 40. Motion analysis engine 52 subsequently computes position and alignment data of instruments 32 and scope camera 34 using stereo triangulation and/or other techniques commonly known in the art. The position and alignment data of instruments 32 and scope camera 34 may be compared with three dimensional models of instruments 32 and scope camera 34, respectively, stored in computer 36. These comparisons may result in the generation of sets of 3D instrument and camera data for use in further processing within processing function 60. Specifically, the output of motion analysis engine 52 may comprise 3D data fields with position and alignment data, linked effectively as packets 54, 56 with associated images from cameras 40, as shown in FIG. 4. Packets 54 may be used for virtual imaging of instruments 32 during training and for evaluating trainee performance while packets 56 may be used for continuous monitoring of the vantage point location of scope camera 34. Scope camera 34 also provides images directly to processing function 60, which may in addition receive training images and stored graphical templates. Outputs of processing function 60 may include actual video, positioning metrics, and/or a simulation output, displayed in various combinations on monitor 38.

Referring to FIG. 4a, in the embodiment shown, with respect to scope camera 34, motion analysis engine 52 may receive the images of scope camera 34 from cameras 40, shown as step 120, with stereo triangulation and/or other techniques used to compute position and alignment data of scope camera 34, as previously described, in step 122. In step 124, a comparison of this position and alignment data with three dimensional data of scope camera 34 may be made to obtain a vantage point location of scope camera 34, resulting in a set of 3D data for further processing, step 126.

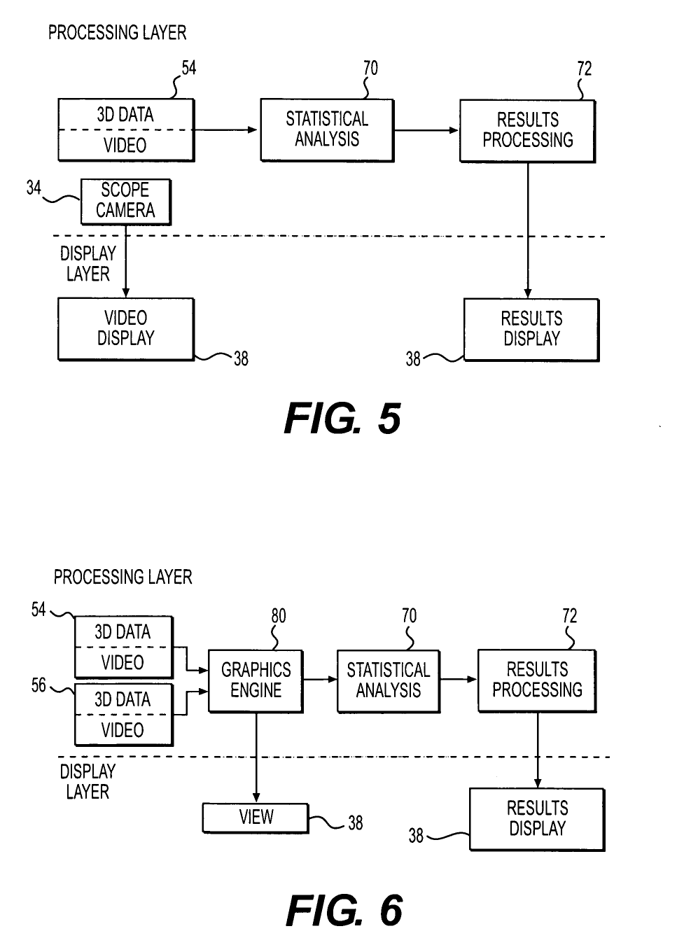

Referring to FIG. 5, in one mode of operation, the trainee manipulates instruments 32 within body form 22 during a surgical training exercise. The trainee or a second individual may operate scope camera 34. As described above, scope camera 34 may provide a live video image of instruments 32 for viewing on monitor 38. The 3D data from packets 54 generated by motion analysis engine 52 is fed to a statistical analysis engine 70, which extracts a number of measures based on the tracked position of instruments 32. A results processing function 72 compares these measures to a previously input set of criteria and generates a set of metrics that score the trainee's performance based on that comparison. Score criteria may be based on time, instrument path length, smoothness of movement, or other parameters indicative of performance. Monitor 38 may display this score alone or in combination with real images produced by scope camera 34.

Referring to FIG. 6, in another mode of operation, the 3D data of packets 54 may be fed into a graphics engine 80, which may render a simulated instrument on display monitor 38 based on the position of actual instruments 32. As the instruments 32 are moved within body form 22, the tracking data is continuously updated, changing the position of the rendered instruments to match that of instruments 32. Graphics engine 80 also includes a view manager for accepting input from packets 56 in order to render a virtual reality simulation of organs within body form 22 from the vantage point of scope camera 34 for display on monitor 38. Alternatively, graphics engine 80 may render an abstract scene containing various other objects to be manipulated. The rendered organs or other objects may have space, shape, lighting, and texture attributes such that upon insertion of instruments 32. For example, graphics engine 80 may distort the surface of a rendered organ if the position of the simulated instrument enters the space occupied by the rendered organ. Within the virtual reality simulation, the rendered models of instruments may then interact with the rendered elements of the simulation to perform various surgical tasks to comport with training requirements. By continuously tracking scope camera 34, the trainee may alter the view shown on display 38 through the manipulation of scope camera 34. Alternatively, in this mode, the trainee may view the rendered models of instruments 32 in a virtual environment from any viewing angle desired. In the mode of operation of the present embodiment, the trainee sees this virtual simulation on monitor 38 as the illusion that rendered instruments 32 are interacting with the simulated organs within body form 22 from the perspective of scope camera 34. In a similar fashion as above, graphics engine 80 feeds the 3D data from packets 54 into statistical analysis engine 70, which in turn feeds into results processing function 72 for comparison to predetermined criteria and subsequent scoring of performance.

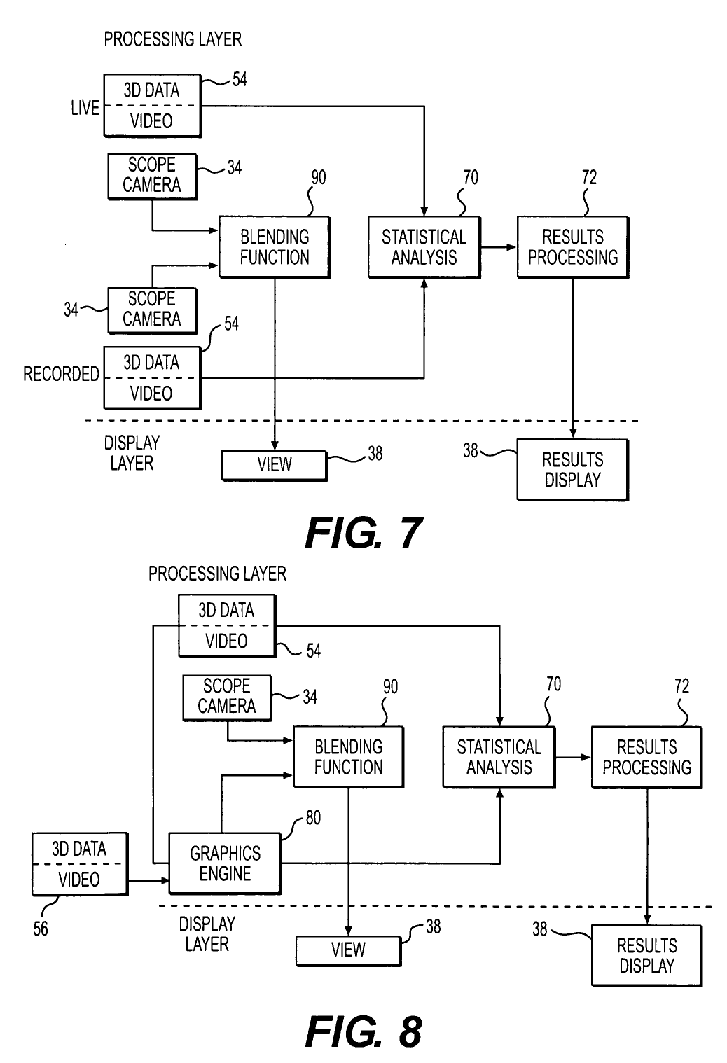

Referring to FIG. 7, in another mode of operation, a blending function 90 within processing function 60 receives live video images from scope camera 34. Blending function 90 then combines these images with a recorded video training stream. Blending function 90 composites the images according to predetermined parameters governing image overlay and background/foreground proportions or, alternatively, may display the live and recorded images side-by-side. The 3D data from packets 54 is fed into statistical analysis engine 70, which in turn feeds into results processing function 72 for comparison to predetermined criteria and subsequent scoring of performance. By blending the trainee's movements with those predetermined by a trainer, training value is achieved through direct and immediate comparison of the trainee (live video stream) with a skilled practitioner (recorded video stream).

In the mode of operation of FIG. 8, the 3D data from packets 56 is fed into graphics engine 80, which in turn feeds a virtual reality simulation of organs, respectively, to blending function 90. These simulated elements are blended with the video data from scope camera 34 to produce a composite video stream, i.e., augmented reality, consisting of a view of live instruments 32 with virtual organs and elements. Specifically, as described above, the tracking of scope camera 34 permits the determination of the viewing perspective of scope camera 34. Once this perspective view is determined, graphics engine 80 may render a virtual image of the body cavity from this perspective view. This virtual image may then be combined with the live image of instruments 32, from the identical perspective of scope camera 34, to produce a detailed augmented reality simulation. The 3D data of packets 54 is also delivered to the statistical analysis engine 70 for processing, as previously described in other modes of operation.

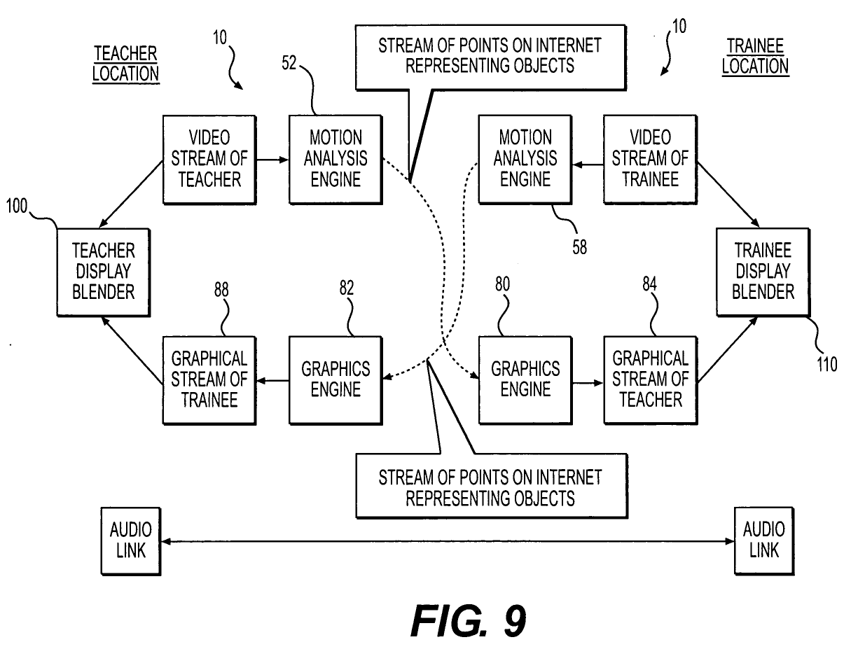

Referring to FIG. 9, the mode of operation presented allows for real-time training though the trainee and skilled practitioner may not be in close proximity. In this mode of operation, a surgical training simulator 10 exists at each of a remote teacher and trainee location. At the teacher location the video stream of the teacher is transmitted to motion analysis engine 52 and to teacher display blender 100. Motion analysis engine 52 at the teacher location may transmit over the internet a low-bandwidth stream comprising position and alignment data of one or more instruments 32 used by the teacher. Graphics engine 80 at the trainee location receives this position and alignment data and constructs graphical representations 84 of the teacher's instruments 32 and any other objects used by the teacher in the training exercise. Using trainee display blender 110, this virtual simulation of the teacher's instruments is blended at the trainee location with the video stream of the trainee. This video is also transmitted to a motion analysis engine 58 at the trainee location. Motion analysis engine 58 at the trainee location transmits a low-bandwidth stream across the internet to graphics engine 82 at the teacher location, which then constructs graphical representations 88 of the trainee's instruments. This virtual simulation of the trainee's instruments is blended with the video stream of the teacher at teacher display blender 100. The combined position and alignment data transmitted over the internet requires significantly less bandwidth than the transmission of video streams. As shown, this training may be supplemented with audio transmission, also over a low bandwidth link.

In all modes of operation described, computer 36 may display in monitor 38 a real-time training exercise or components of a training exercise previously performed and recorded, or various combinations thereof.

In one or more of these described modes of operation, actual objects may be inserted in body form 22. Such objects may be utilized to provide haptic feedback upon contact of an object with instruments 32. The inserted objects may also be used as part of the surgical training procedure, in which, for example, an object may be moved within body form 22 or an incision, suture, or other procedure may be performed directly on or to an inserted object.

It will be apparent to those skilled in the art that various modifications and variations can be made to the disclosed system for simulating a surgical procedure. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A surgical training device, comprising:
a body form;
an optical tracking system within the body form;
a camera configured to be optically tracked and to obtain images of at least one surgical instrument located within the body form;
a computer configured to receive signals from the optical tracking system; and
a display operatively coupled to the computer and operative to display the images of at least one surgical instrument and a virtual background, the virtual background depicting a portion of a body cavity, the virtual background displayed from a perspective of the camera configured to be optically tracked.

2. The surgical training device of claim 1, wherein the images of the at least one surgical instrument are from a perspective of the camera configured to be optically tracked.

3. The surgical training device of claim 1, wherein the images of the at least one surgical instrument are virtual images.

4. The surgical training device of claim 1, wherein the images of the at least one surgical instrument are live video images.

5. The surgical training device of claim 1, wherein the camera configured to be optically tracked is operative within the body form for up to six degrees of freedom.

6. The surgical training device of claim 1, wherein the images of the virtual background are continual throughout at least one degree of freedom of movement of the camera configured to be optically tracked.

7. The surgical training device of claim 1, wherein the images of the virtual background are continual throughout six degrees of freedom of movement of the camera configured to be optically tracked.

8. The surgical training device of claim 1, wherein the computer is configured to generate one or more performance metrics.

9. The surgical training device of claim 8, wherein the display is operative to display the one or more performance metrics with at least one image of at least one surgical instrument.

10. The surgical training device of claim 1, wherein the computer is configured to compare the position and alignment data of the camera configured to be optically tracked with at least one digitally stored model of a camera.

11. A method of surgical training, comprising:
obtaining image data of at least one surgical instrument from a camera located within a body form;
optically tracking the camera;
transmitting signals corresponding to position and alignment information of the camera;
receiving the signals in a computer;
displaying the image data of the least one surgical instrument; and
displaying from a perspective of the camera a virtual background, the virtual background depicting a portion of a body cavity.

12. The method of claim 11, wherein displaying the image data of the least one surgical instrument includes displaying from a perspective of the camera.

13. The method of claim 11, wherein displaying the image data of the at least one surgical instrument includes displaying a virtual image.

14. The method of claim 11, wherein displaying the image data of the at least one surgical instrument includes displaying a live video image.

15. The method of claim 11, wherein optically tracking the camera includes optically tracking for up to six degrees of freedom.

16. The method of claim 11, wherein displaying from a perspective of the camera a virtual background includes continually displaying throughout at least one degree of freedom of movement of the camera.

17. The method of claim 11, wherein displaying from a perspective of the camera a virtual background includes continually displaying throughout six degrees of freedom of movement of the camera.

18. The method of claim 11, further including: generating one or more performance metrics.

19. The method of claim 18, further including: displaying the one or more performance metrics with at least one image of at least one surgical instrument.

20. A method of surgical training, comprising:
obtaining image data of at least one surgical instrument from a camera located within a body form;
optically tracking the camera;
transmitting signals corresponding to position and alignment information of the camera;
receiving the signals in a computer;
generating three dimensional position and alignment data for the camera;
comparing the position and alignment data with at least one digitally stored model of the at least one camera;
displaying the image data of the least one surgical instrument; and
displaying from a perspective of the camera a virtual background, the virtual background depicting a portion of a body cavity.
